(19) United States
(12) Patent Application Publication
(10) Pub. No.: US 2026/0229033 A1
(43) Pub. Date: Aug. 6, 2026

(54) A COMPUTER IMPLEMENTED METHOD OF SELECTING A SUBSET OF IMAGES FROM A DATABASE COMPRISING A PLURALITY OF INITIAL IMAGES FROM A MICROSCOPY SAMPLE

(71) Applicant: CYTELY AB, Malmö (SE)

(72) Inventors: Per Oscar Albin André, Lund (SE); Bill Pontus Nordenfelt, Södra Sandby (SE); Johannes RagnvaldKumra Ahnlide, Lund (SE)

(21) Appl. No.: 19/154,874

(22) PCT Filed: Feb. 8, 2024
(86) PCT No.: PCT/SE2024/050113

§ 371 Date: Aug. 8, 2025

(30) Foreign Application Priority Data
Feb. 10, 2023 (SE) 2350128-1

(51) Int. Cl. G06V 20/30; G02B 21/36; G06F 16/583; G06T 7/60; G06T 7/73; G06V 20/69

(52) U.S. Cl. CPC G06V 20/30; G02B 21/365; G06F 16/583; G06T 7/60; G06T 7/73; G06V 20/693; G06T 2207/10056; G06T 2207/30024; G06T 2207/30168; G06V 2201/03

(57) ABSTRACT

A computer implemented method comprises providing a database (2) comprising a plurality of initial images (11) . Each initial image (11) being an image of a different portion of a microscopy sample (10) comprising a number of objects (31, 32). Selecting a subset of the plurality of the initial images (11) , the selection being based on a determined dimension of a microscopic feature (31, 32, 33) in at least one of the initial images (45).

The invention relates to a method implemented on a computer of selecting a subset of a plurality identifying an initial image from a number of initial images in a microscopy sample.

Light microscopy is a powerful single-cell technique that allows for quantitative spatial information at subcellular resolution. However, unlike flow cytometry and single-cell sequencing techniques, microscopy has issues achieving high-quality population-wide sample characterization while maintaining high resolution resulting in a compromise between resolution and population context. It is especially challenging to know the contextual relevance of data being acquired for high-resolution live imaging applications where the field of view limits cell population analysis.

For example, it is difficult for cell migration and infection studies to capture events of interest, rare or common, with high precision and high resolution and/or magnification.

There is also the additional challenges of reducing human bias, increasing reproducibility, and placing single-cell characteristics in the context of the sample population when interpreting microscopy data. These can all result in a reduction in data fidelity.

For example, in most high-resolution microscopy applications, images are typically only acquired from selected points, lacking population context and risk of bias, especially since data selection is often left to human operators. Even more demanding is to ensure that relevant data is acquired during live imaging, such as when recording high-resolution cell migration data or capturing host-pathogen interactions.

Integrating image analysis, including machine learning classification algorithms, into the data selection has improved the efficiency and reduced the overall bias of image acquisition. These solutions, referred to as event-driven feedback microscopy or intelligent microscopy, allow for the high-throughput targeted imaging of cells of interest in high-spatiotemporal settings. Such decisions are typically based on predetermined criteria of image characteristics through image segmentation and are not adaptive to the data distribution of a particular sample population.

In accordance with a first aspect of the invention, there is provided a computer implemented method comprising:
a. providing a database comprising a plurality of initial images, each initial image being an image of a different portion of a microscopy sample comprising a number of objects;
b. selecting a subset of the plurality of the initial images, the selection being based on a determined dimension of a microscopic feature in at least one of the initial images.

Preferably, the method further comprises:
c. selecting a portion of the microscopy sample corresponding to one of the images of the subset; and
d. capturing a first image of the portion or of a sub-section of the portion.

Typically, the method may further comprise:
e. capturing a second image of the portion or the sub-section; and wherein the second image is captured at a time interval after capture of the first image.

Typically, a number of further images may be captured, each of the number of further images being captured at different time intervals after capture of the second image. The different time intervals may be substantially equal to or substantially multiples of the time interval between capture of the first and second images.

The time interval may be between 10 seconds and 30 minutes, preferably between 1 minute and 30 minutes and more preferably between 5 minutes and 30 minutes.

For example, the time interval may be 10 minutes or 20 minutes.

Preferably, the first image, and any second or further images, are captured at at least one of: (i) a higher resolution than the initial images; and (ii) a higher magnification than the initial images. Where they are captured at a higher resolution, the higher resolution may be at least one of a higher spatial resolution and a higher temporal resolution.

The determined dimension of the microscopic feature may be pre-determined or may be user selected.

Preferably, the determined dimension of the microscopic feature comprises at least one of: (i) a dimension of an object; and (ii) the distance between two objects.

In one example of the invention, the microscopic feature may be two objects, such as two adjacent objects. The two objects may be determined objects. The determined objects may be predetermined or may be user selected.

Typically, the determined dimension may comprise a range having at least one of a lower limit and an upper limit. Preferably, where the determined dimension is a separation between two objects, the determined dimension has an upper limit. Typically, the selected subset comprises initial images in which two adjacent objects have a separation less than or equal to the upper limit.

In one example of the invention, the microscopic feature may be two objects with a separation less than or equal to an upper limit or threshold. Typically, the separation is less than or equal to 25 μm, more preferably less than or equal to 10 μm and even more preferably less than 5 μm. Most preferably, the separation is less than or equal to 4 μm and may be less than or equal to 3.7 μm. Preferably, the separation is at least 1 μm.

Preferably, the initial images cover substantially all fields of view of the microscopy sample in at least one plane, such as a plane substantially perpendicular to an optical axis of a microscope.

Preferably, the initial images include multiple images of each field of view and each of the multiple images of a field of view are captured at a different initial time interval. The multiple images for each field of view may include images for a number of different channels captured at each initial time interval. Typically, the number of multiple images of each field of view may be between two and ten per channel. However, it is also possible that there may be more than ten images per channel for each field of view.

The initial time interval may be between 10 seconds and 30 minutes, preferably between 1 minute and 30 minutes and more preferably between 5 minutes and 30 minutes. For example, the initial time interval may be 10 minutes or 20 minutes.

Typically, the initial images cover the microscopy sample in at least one of an XY plane of the sample and the Z axis of the sample, the XY plane being defined as a plane substantially perpendicular to an optical axis of a microscope.

Preferably, the method further comprises controlling a microscope having an image capture device to capture the plurality of initial images; and creating the database comprising the plurality of initial images.

Typically, at least one of the objects is a biological object, such as at least one of a cell and a non-cellular organism. Either of the objects may be a pathogen, such as a virus, bacterium, parasite, or fungus.

The selection in step b. may also be based on at least one additional parameter, the at least one additional parameter may be an image property or a property of an object in an image selected from: intensity; signal to noise ratio; density; shape; size; and, contrast.

Preferably, the method is a method of identifying interactions between biological objects in the microscopy sample, such as an interaction between a cell and a pathogen.

In accordance with a second aspect of the present invention, there is provided apparatus for implementing the method according to the first aspect. The apparatus may typically comprise a storage means for storing the database and a processor coupled to the database for selecting the subset.

Typically, where the method further comprises capturing first, second or further images, the apparatus is configured to create another database of the further captured images and to store the other database on the storage means or another storage means.

Where the method further comprises controlling a microscope, the apparatus may further comprise a microscope having an image capture device, the microscope and image capture device coupled to the computer to permit the computer to control the image capture device and the microscope and to receive captured images from the image capture device.

In accordance with a third aspect of the present invention, there is provided a method of identifying interactions in a microscopy sample, the method comprising:
a. mounting the sample containing at least two objects on a microscope;
b. capturing on an image capture device a number of initial images of different portions of the sample; and
c. using a processor to analyse the initial images to identify a portion of the sample including two objects having a separation less than a threshold.

Typically, the initial images are all captured at the same magnification and resolution.

Preferably, the method of the third aspect further comprises:
d. capturing a first image of the portion; and
wherein the processor analyses the first image of the portion to determine whether the two biological objects are interacting or have interacted with each other.

The first image may be captured at at least one of: a higher magnification; and a higher resolution than the initial images. The higher resolution may be a higher spatial resolution and/or a higher temporal resolution.

Typically, the method of the third aspect further comprises:
e. capturing a second image of the portion; and
   wherein the second image is captured at a time interval after capture of the first image; and the processor compares the first image of the portion and the second image of the portion to determine whether the two biological objects are interacting or have interacted with each other.

Typically, a number of further images are captured, each of the number of further images being captured at different time intervals after capture of the second image.

The different time intervals may be substantially equal to or substantially multiples of the time interval between capture of the first and second images.

Preferably, at least one of the objects is a cell. For example, at least one of the biological objects may be a eukaryotic cell or a microorganism, such as bacteria, algae, virus or protozoa. However, it is possible that at least one of the objects could be a non-biological object, such as a latex particle.

In one example of the invention, one of the objects is a micoorganism. For example, the organism may be a pathogen, such as a virus, bacterium, parasite, or fungus.

Preferably, the analysis further comprises analysing at least one additional parameter of the two biological objects. The at least one additional parameter may be selected from: intensity; signal to noise ratio; density; shape; size; and, contrast.

Typically, the selection of the subset is also based on the at least one additional parameter.

The method may further comprise identifying the location of the microscopic feature in each of the images of the subset and using the locations in the images to identify the portions of the sample containing the microscopic feature. Identifying the locations may comprise identifying the coordinates of the microscopic feature in the images.

Preferably, steps b and c of the third aspect are repeated until one of: a portion of the sample is identified in which two biological objects have a separation less than a threshold or less than an upper limit.

Typically, the method further comprises storing the captured images on a memory device.

An example of a computer implemented method of selecting a subset of a plurality of initial images in a microscopy sample will now be described with reference to the accompanying drawings, in which:

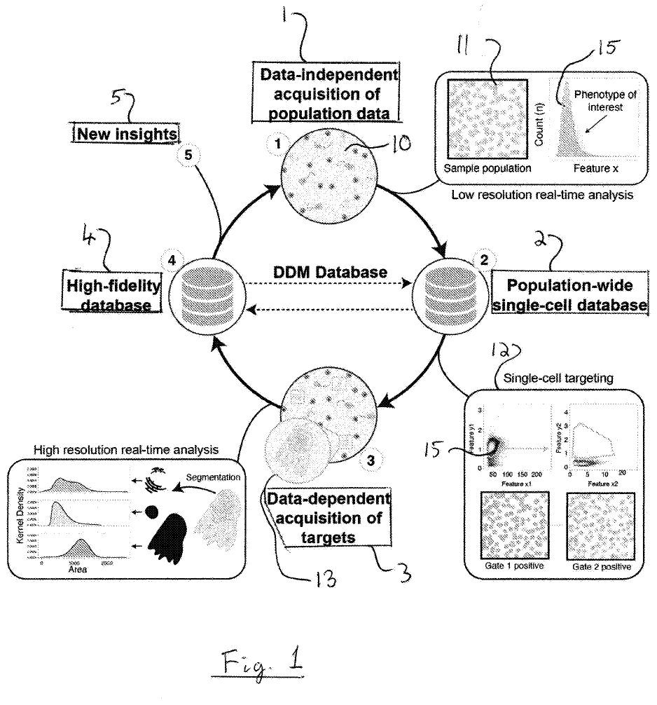

FIG. 1 is a schematic diagram illustrating the process of data-driven microscopy;

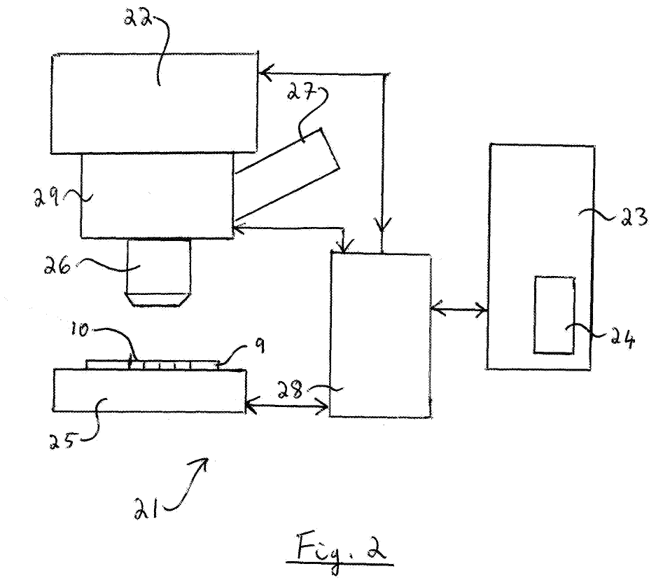

FIG. 2 is a block diagram of an example of hardware for implementing the process of FIG. 1;

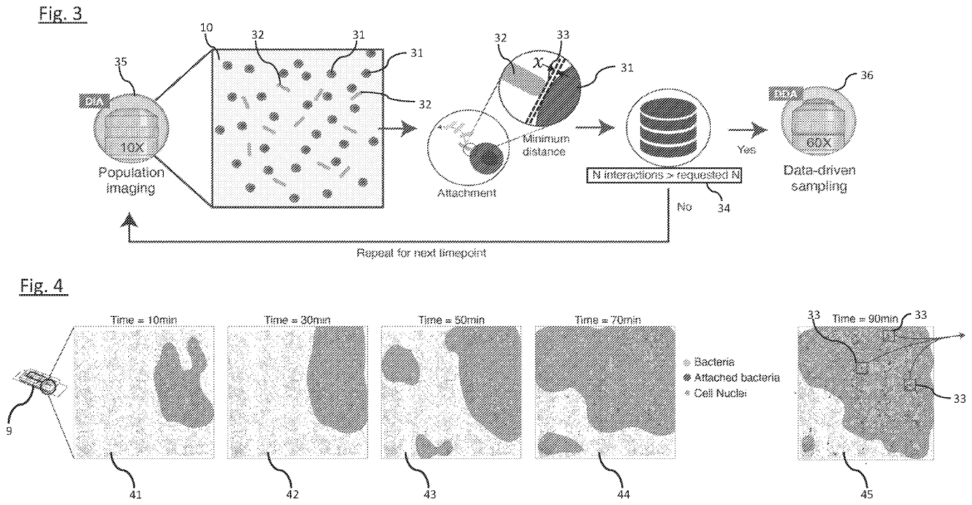

FIG. 3 is a schematic diagram illustrating a data-driven microscopy process for identification of interaction of biological objects.

FIG. 4 shows a series of five time lapse images obtained during a data independent acquisition phase of the process shown in FIG. 3.

FIGS. 5a to 5c show a series of time lapse images for three different interactions identified in FIG. 4;

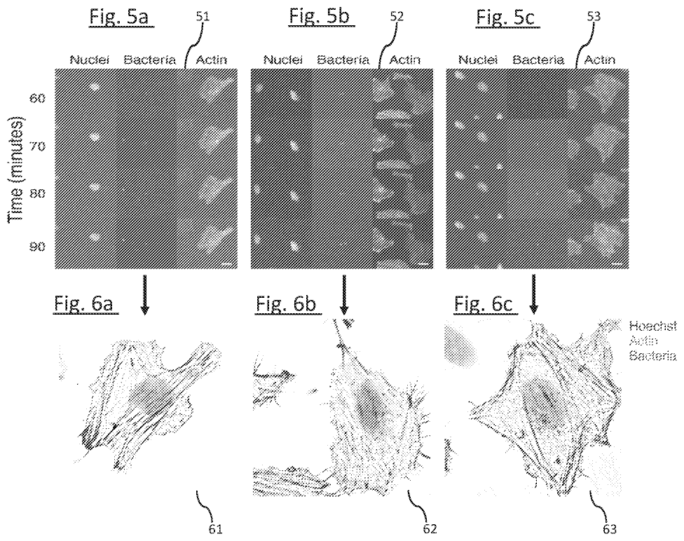

FIGS. 6a to 6c show the three different interactions of FIG. 5 imaged using a data driven acquisition phase; and

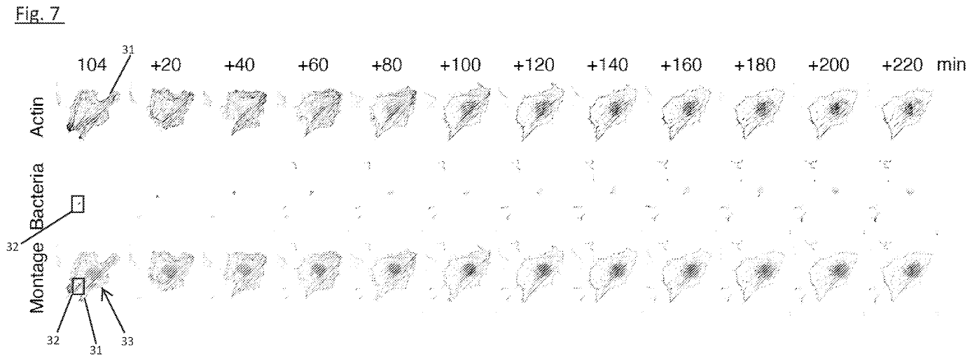

FIG. 7 shows a series of twelve time lapse images for the interaction shown in FIG. 6a.

The term “dimension” as used herein is intended to refer to a measurable extent of a particular kind, such as length, breadth, depth or height of an object, or distance (or separation) between two objects.

Data-driven microscopy is built around two imaging strategies interconnected through a shared server database and is an approach for automated targeted image acquisition of relevant data. The data-driven microscopy process is illustrated schematically in FIG. 1 and a block diagram of suitable hardware is shown in FIG. 2. The first imaging strategy is data independent acquisition (DIA) 1. The purpose of the DIA 1 is to capture and characterise the full sample population in real-time. The DIA 1 provides complete population characterization at a single-cell level of a biological sample 10 mounted on a microscope 21. Also mounted on the microscope 21 is a suitable camera 22 capable of capturing images of the sample 10. The combination of the microscope 21 and camera 22 is commonly known as a digital optical microscope. The microscope 21 comprises a motorised stage 25, an objective lens 26 an eyepiece 27 and control electronics 28. The control electronics 28 are connected to the camera 22 and to the motorised stage 28 and the main microscope body 29. The sample 10 was located in a suitable sample holder, such as a μ-slide 8-well glass-bottom slide (Ibidi) 9.

The microscope 21 may be an inverted Nikon® Ti2-E wide-field fluorescence microscope used with a Nikon® Plan Apo λ10×0.45 numerical aperture (NA) objective lens and Perfect Focus System (PFS) for maintenance of focus over time. The camera 22 may be a Nikon® DS-Qi2 CMOS camera. The imaging of the samples was automated by generating stage positions covering the sample area using JOBS (NIS322 Elements extension; Nikon®) and a Nikon® TI-S-ER motorized stage with an encoder. The same system was also used with a Nikon® CFI SR Plan Apo IR 60XAC WI/1.27 NA objective lens with a software-driven TI2-N-WID Water Immersion Dispenser. Typically, the 10×0.45 NA objective lens is used for DIA and the 60xAC WI/1.27 NA objective lens is used for DDA. However, it is possible the same objective lens can be used for both DIA and DDA. Alternatively or in addition, It is also possible that the temporal and/or spatial resolutions could be changed between DIA and DDA, with typically a higher spatial and/or temporal resolution being used for DDA.

The generated single cell data captured from the sample 10 using the microscope 21 and camera 22 is continuously output from the control electronics to a computer server 23 and stored on a storage device 24 in the server 23 in a DIA database 2. The storage device is typically in the form of a hard disk drive (HDD) or a solid-state drive (SSD). The server may be connected to the microscope 21 and camera 22 in close proximity, for example, via ethernet, a wireless connection or USB cable. Alternatively, the server 23 may be located in a remote location (such as in the cloud) and connected, for example, via the Internet.

From this database 2, a user can define cells of interest by exploring and filtering on features (gating) or criteria 15, either post-acquisition or in real time. Therefore, the DIA database 2 permits real-time analysis of images 11 acquired by the microscope 21 and camera 22 and the filtering of data in the DIA database 2 and single-cell targeting 12 to generate targeting criteria 15. Alternatively, the targeting criteria 15 can be predefined. Examples of features or criteria 15 in the biological sample that may be used for filtering include: dimensions of biological objects present in the sample, such as cells, bacterium or other pathogens; other dimensions, such as separation between different biological objects; and size of biological objects.

The predefined or generated targeting criteria 15 are then fed back to the microscope 21 for the second imaging strategy, which is data-dependent acquisition (DDA) 3. The DDA 3 performs targeted high-fidelity imaging of the biological objects or events of interest 13. The fidelity can be increased by increasing one or more of spatial resolution, temporal resolution and magnification or by imaging with a different modality. The DDA 3 can be performed subsequent to the DIA 1, where gating is done in real-time using stored stage coordinates corresponding to each image captured and stored in the database 2 or with gates from a separate DIA experiment.

High-fidelity data from the DDA 3 is then stored in a high-fidelity database 4, which is interconnected to the DIA database 2. This results in high-fidelity data in a high-fidelity database 4 in the context of the entire sample population. The interconnection of DIA and DDA databases allows for high-fidelity data to be placed in the sample-wide context.

With access to both databases 2, 4, the user can further explore the data in its relative context and uncover new insights 5 that may motivate further experiments. Taken together, a synergistic relationship can be established between the two imaging strategies, increasing the fidelity as well as the relevance of the data by placing biological objects (or features) of interest in their population context.

For example, the process described above enables a user to determine whether a particular biological feature or event is an anomaly within the biological sample or a common characteristic of the sample.

Therefore, as described above in relation to FIG. 1, the DDM process enables automated high-fidelity sampling of targeted multi-labeled subpopulations.

As mentioned above in relation to FIGS. 1 and 2, the DDM process can be used for the identification and acquisition of events, such as interactions between biological objects, in the biological sample 10. Such interactions may be, for example, host-pathogen interactions (such as bacteria-cell interactions) or cell-cell interactions.

When imaging live host-pathogen interactions, a major issue is to predict where in the sample such events might happen, especially as many of the interactions might be rare events and temporarily dependent. To validate the live-cell and the capturing of rare events capabilities of DDM, a data-driven approach to target live single-cell interactions between cells and bacteria was developed, which is illustrated in FIG. 3.

Hela cells 31 were used expressing mScarlet-LifeAct and the bacterial pathogen Yersinia pseudotuberculosis 32 expressing GFP. Through DIA, the sample populations of Hela cells 31 (population=16988 cells) and Y. pseudotuberculosis 32 (population=990 bacterium) and their interactions 33 (number of interactions=120) were monitored over time using time-lapse photography to capture images 41, 42, 43, 44, 45 at 10 min, 30 min, 50 min, 70 min and 90 min respectively (see FIG. 4).

In this experiment, there were approximately 20 different fields of view for the sample 10. An image of each field of view was captured at each of four different microscope channels for each of the time intervals. Hence, using DIA 35, captured approximately 400 images for the DIA database 2.

A live-cell imaging system of HeLa mScarlet-LifeAct cells 31 and the bacterial pathogen Yersinia pseudotuberculosis 32 was set up. Using DIA 35, interactions in the form of attachment between 990 bacteria 32 and 16 988 cells 31 were monitored using time-lapse photography to capture images over time intervals of 20 minutes (see FIGS. 4) and 120 interactions were identified. Upon identification, these 120 interactions were targeted for DDA 36. Using the DIA 35, revealed the interactions to be sparse across the sample. Interactions were categorized according to a minimum distance x between each bacterium 32 and its closest neighbouring cell 31. The minimum distance x was determined based on thresholding the Euclidean distance between each bacteria and closest segmented actin signal. Three potential interactions 33 are identified in the last image 45 (Time=90 min) of FIG. 4.

For the purposes of this experiment there was determined to be a potential interaction 33 between the cell 31 and the bacterium 32 if the minimum distance×was less than or equal to 3.7 μm for at least 20 minutes or for at least three of the time-lapse captured images 41, 42, 43, 44, 45 in FIG. 4.

FIGS. 5a to 5c each show four time-lapse images 51, 52, 53 of each of the three bacteria-cell interactions 33 respectively from FIG. 4 with bacteria 32 attached to cells 31 and imaged using DIA 35 (10× magnification; scale bars are 25 μm). In each of FIGS. 5a to 5c the time-lapse images in each of images 51, 52, 53 were captured every 10 min. Upon meeting a predefined number 34 of interactions 33 in DIA 35, bacteria-cell interactions were automatically targeted for high-fidelity live-cell imaging in DDA 36 This was based on two independent experiments which selected 120 fields of view.

FIGS. 6a to 6c show example images 61, 62, 63 of the same three bacteria-cell interactions 33 shown in FIGS. 5a to 5c, respectively, targeted and imaged in the DDA 36 (60× magnification; scale bars are 10 μm). Image 61 corresponds to image 51, image 62 corresponds to image 52 and image 63 corresponds to image 53.

Y. psuedotuberculosis disrupt host cell function by interfering with actin filament formation through the injection of multiple toxins through its type-three-secretion system. FIG. 7 shows twelve time-lapse images of the interaction 33 shown in image 61 in FIG. 6a. In FIG. 7 each image was captured at a time interval of 20 minutes after the previous image. In FIG. 7, “104” (t=104 minutes) refers to the time in minutes after image acquisition begins. Each subsequent image capture being at 20 minute intervals up to 220 minutes after t=104 minutes, as indicated along the top of FIG. 7.

In FIG. 7 at each of the time intervals, the top image shows the cell 31, the middle image shows the bacterium 32 and the bottom image shows both the cell 31 and the bacterium 32. These images reveal a clear effect on the host cell 31 actin morphology and dynamics by the bacterium 32. Data is based on two independent experiments which captured 120 independent time-lapse acquisitions of host-cell bacteria interactions from the corresponding 120 fields-of-view.

When selecting an interaction to investigate further using DDA, the selection of the interaction may be at least partly based on at least one additional parameter of the feature and/or biological objects, such as: intensity; signal to noise ratio; density; shape; size; and, contrast.

In the experiment described above using DDM, all events were captured and a hit rate of 100% was achieved.

Comparatively, a traditional approach for acquiring high-resolution cell-bacteria interaction based on manual monitoring would achieve an estimated hit rate of only 1.4% in the same experiment based on the fraction of interacting bacteria and cells in the sample. In addition, population data on the sample would not be available with standard approaches, making assessing the overall association inaccessible.

FIGS. 6a to 6c show three examples from DDA. FIG. 7 shows a representative outcome of a bacteria-cell interaction over time. Thus, this demonstrates the adaptability and capacity of DDM to acquire population-wide data and the subsequent targeting of temporally dependent and rare events for live-cell imaging over time.

DDM implements a data-centric approach to image acquisition. The initial scan using DIA 1 to collect overview data also leads to one of the most obvious benefits of the approach in that it provides coordinates and basic features of the objects in the sample. This basic sample overview data allows for real-time analysis of population context based on objective data rather than the subjective experience of the microscopist.

In addition, the population data can then be filtered (gating) on additional channels to decide which data should be collected. For example, additional filtering can be based on image properties or object properties, such as intensity; signal to noise ratio; density; shape; size; and, contrast.

DDM also inherently provides information on what constitutes representative objects in the sample population. Cells can be considered representative when they are placed in the context of the population feature distribution.

For live interaction studies, such as that described above and shown in FIGS. 3 to 7, using DDM leads to a dramatic increase in hit rate (in the current example from 1.4% to 100%) for high-resolution data collection compared to traditional approaches. There is also the valuable addition of population-wide context compared to other feedback microscopy solutions .. DDM uses the best aspect of each modality and controls acquisition in an automated and efficient manner, resulting in large, context-aware data sets with high fidelity.

DDM allows for significant benefits post-acquisition compared to the current state-of-the-art. To increase introspection and reproducibility, DDM inherently logs all operations performed, as well as the state of the running experiment, providing clear status updates to the user. Since DDM essentially provides a population fingerprint for each experiment, it makes it less prone to human error and bias.

In this work, as proof-of-principle, we have established the DDM framework on Nikon® digital microscopes. The framework is compatible with any digital microscope 21, 22 provided the controlling software can send images to the server 23 or invoke external programs to achieve this. In summary, DDM offers a useful framework for a more robust and unbiased acquisition of high-fidelity microscopy data.

Although in the example described above, the sample is a biological sample and interaction between biological objects or entities is analysed or investigated. The sample could be a microscopic sample including non-biological objects and the interaction between non-biological objects in the sample investigated. For example, the non-biological objects could be beads or particles, such as latex particles, coated with a chemical or biological substance such as a protein. The invention could be used to investigate the interaction between beads or particles with these coatings, for example, the interactions between two beads or particles coated with different proteins.

1. A computer implemented method comprising:
a. providing a database comprising a plurality of initial images, each initial image being an image of a different portion of a microscopy sample comprising a number of objects;
b. selecting a subset of the plurality of the initial images, the selection being based on a determined dimension of a microscopic feature in at least one of the initial images.

2. A method according to claim 1, further comprising:
c. selecting a portion of the microscopy sample corresponding to an image of the subset; and
d. capturing a first image of the portion or of a sub-section of the portion.

3. A method according to claim 2, further comprising:
e capturing a second image of the portion or the sub-section; and wherein the second image is captured at a time interval after capture of the first image.

4. A method according to claim 3, wherein a number of further images are captured, each of the number of further images being captured at different time intervals after capture of the second image.

5. A method according to claim 4, wherein the different time intervals are substantially equal to or substantially multiples of the time interval between capture of the first and second images.

6. A method according to claim 2, wherein the first image, and any second or further images, are captured at at least one of: (i) a higher resolution than the initial images; and (ii) a higher magnification than the initial images.

7. A method according to claim 6, wherein the higher resolution may be at least one of a higher spatial resolution and a higher temporal resolution.

8. A method according to claim 1, wherein the microscopic feature may be selected during selection of the subset or may be selected prior to selection of the subset.

9. A method according to claim 1, wherein the dimension of the microscopic feature comprises at least one of: (i) a dimension of an object; and (ii) the distance between two objects.

10. A method according to claim 1, wherein the dimension comprises a range having at least one of a lower limit and an upper limit.

11. A method according to claim 1, wherein the initial images cover substantially all of the microscopy sample.

12. A method according to claim 1, wherein the initial images cover the sample in at least one of the XY plane of the sample and the Z axis of the sample.

13. A method according to claim 1, further comprising controlling a microscope having an image capture device to capture the plurality of initial images; and creating the database comprising the plurality of initial images.

14. A method according to claim 1, wherein at least one of the objects is a eukaryotic cell or a microorganism;

15. A method according to claim 1, wherein the selection of the subset in step b. is also based on at least one additional parameter, the at least one additional parameter being selected from: intensity; signal to noise ratio; density; shape; size; and, contrast.

16. A method according to claim 1, wherein the method is a method of identifying interactions between objects in the sample.

17. A data processing apparatus comprising means for carrying out the method of claim 1.

18. A computer program comprising instructions which, when the program is executed by a computer, cause the computer to carry out the method of claim 1.

19. A computer-readable storage medium comprising instructions which, when executed by a computer, cause the computer to carry out the method of claim 1.
